(19) United States
(12) Patent Application Publication
(10) Pub. No.: US 2025/0087755 A1
(43) Pub. Date: Mar. 13, 2025

(54) SECONDARY BATTERY COMPRISING NON-AQUEOUS ELECTROLYTE

(71) Applicant: Apple Inc., Cupertino, CA (US)

(72) Inventors: Hongli Dai, Los Altos, CA (US); Jongho Jeon, Cupertino, CA (US); Qian Liu, Lemont, IL (US); Zhengchang Zhang, Lemont, IL (US); James A. Gilbert, Bolingbrook, IL (US)

(21) Appl. No.: 18/818,206

(22) Filed: Aug. 28, 2024

Related U.S. Application Data
(60) Provisional application No. 63/581,090, filed on Sep. 7, 2023.

(51) Int. Cl. H01M 10/0569; H01M 10/0567; H01M 10/0568

(52) U.S. Cl. CPC H01M 10/0569; H01M 10/0567; H01M 10/0568; H01M 2300/0037; H01M 2300/0051

(57) ABSTRACT

This disclosure relates generally to battery cells, and more particularly, electrolyte solvents for use in lithium-ion battery cells.

### PRIORITY

This patent application claims the benefit of U.S. Provisional Patent Application No. 63/581,090, entitled “NON-AQUEOUS ELECTROLYTE AND SECONDARY BATTERY COMPRISING THE SAME”, filed on Sep. 7, 2023, which is incorporated herein by reference in its entirety.

### U.S. GOVERNMENT LICENSE RIGHTS

This invention was made with U.S. government support under WFO Proposal No. 85C85 TO 0006. This invention was made under a CRADA 1500801 between Apple Inc. and Argonne National Laboratory operated for the United States Department of Energy. The U.S. government has certain rights in the invention.

### FIELD

This disclosure relates generally to battery cells, and more particularly, electrolyte additives for use in lithium-ion battery cells.

### BACKGROUND

Li-ion batteries are widely used as the power sources in consumer electronics. Consumer electronics include Li-ion batteries which can deliver higher volumetric energy densities and sustain more discharge-charge cycles.

A battery life cycle can deteriorate due to degradation of the cathode active material structure. Cathode active material stability can be improved by using electrolyte fluids that limit cathode active material degradation.

### SUMMARY

In a first aspect, the disclosure is directed to an electrolyte fluid with a solvent comprising dimethyl carbonate (DMC) and ethylmethylcarbonate (EMC). In some variations, the combined quantity of DMC and EMC is 50 wt %-80 wt % of the electrolyte fluid. In some variations, the wt % ratio of DMC:EMC is from 1:4::4:1. In some variations, DMC is in an amount from 10 wt %-70 wt % of the electrolyte fluid, and EMC is in an amount from 10 wt %-70 wt % of the electrolyte fluid, wherein the total amount of DMC and EMC does not exceed 80 wt %. In some variations, DMC is from 20 to 70 wt % of the total electrolyte fluid, and/or EMC is from 10 to 50 wt % of the total electrolyte fluid, wherein the total amount of DMC and EMC does not exceed 80 wt %.

In a second aspect, the solvent also includes propylene carbonate (PC) and ethylene carbonate (EC). In some variations, PC is from 2 to 20 wt % of the total electrolyte fluid and EC is from 5 to 40 wt % of the total electrolyte fluid.

In a third aspect, the electrolyte fluid includes a lithium salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

In a fourth aspect, the electrolyte fluid includes an additive selected from lithium difluoro(oxalato)borate (LiDFOB), succinonitrile (SN), propane sultone (PS), 1,3,6-hexanetricarbonitrile (HTCN), and a combination thereof.

In a fifth aspect, the disclosure is directed to a battery cell. The battery cell can include a cathode having a cathode active material disposed on a cathode current collector, and an anode having an anode active material disposed on an anode current collector. The anode is oriented towards the cathode such that the anode active material faces the cathode active material. A separator is disposed between the cathode active material and the anode active material. An electrolyte fluid as described herein is disposed between the cathode and anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a perspective view of a battery cell, in accordance with an illustrative embodiment;

FIG. 3A depicts the discharge capacity of Electrolyte Fluid 1 and Electrolyte Fluid 2 as a function of cycle count, in accordance with an illustrative embodiment;

FIG. 3B depicts the energy retention of Electrolyte Fluid 1 and Electrolyte Fluid 2 as a function of cycle count, in accordance with an illustrative embodiment;

FIG. 3C depicts the internal resistance (RSS) at 20% state of charge (SoC) of Electrolyte Fluid 1 and Electrolyte Fluid 2 as a function of cycle count, in accordance with an illustrative embodiment;

FIG. 4A depicts the discharge capacity as a function of cycle count for Electrolyte Fluid 1 and Electrolyte Fluid 2 in a battery cell operating at 4.52V and 45° C., in accordance with an illustrative embodiment;

FIG. 4B, energy retention as a function of cycle count for Electrolyte Fluid 1 and Electrolyte Fluid 2 in a battery cell operating at 4.52V and 45° C., in accordance with an illustrative embodiment;

FIG. 4C depicts the internal resistance (RSS) at 20% state of charge (SoC) as a function of cycle count for Electrolyte Fluid 1 and Electrolyte Fluid 2 in a battery cell operating at 4.52V and 45° C., in accordance with an illustrative embodiment;

FIG. 5A depicts the discharge capacity as a function of cycle count for Electrolyte Fluid 1 and Electrolyte Fluid 2 in a battery cell having a blended cathode and operating at 4.52V and 45° C., in accordance with an illustrative embodiment;

FIG. 5B depicts energy retention as a function of cycle count for Electrolyte Fluid 1 and Electrolyte Fluid 2 in a battery cell having a blended cathode and operating at 4.52V and 45° C., in accordance with an illustrative embodiment;

FIG. 5C depicts the internal resistance (RSS) at 20% state of charge (SoC) as a function of cycle count for Electrolyte Fluid 1 and Electrolyte Fluid 2 in a battery cell having a blended cathode and operating at 4.52V and 45° C., in accordance with an illustrative embodiment;

FIG. 5D depicts the energy retention as a function of cycle count of a battery cell containing Electrolyte Fluid 1 (504) and Electrolyte Fluid 2 (502) operating voltage of 4.52 V at 25° C., in accordance with an illustrative embodiment;

FIG. 6A depicts the energy retention as a function of cycle count of a battery cell containing Electrolyte Fluid 1 (604) and Electrolyte Fluid 2 (602) at an operating voltage of 4.52 V at 25° C. normalized to the first cycle, in accordance with an illustrative embodiment;

FIG. 6B depicts the discharge capacity as a function of cycle count for Electrolyte Fluid 1 and Electrolyte Fluid 2 in a battery cell at an operating voltage of 4.52V at 45° C., in accordance with an illustrative embodiment;

FIG. 6C depicts the energy retention as a function of cycle count of a battery cell containing Electrolyte Fluid 1 (604) and Electrolyte Fluid 2 (602) at an operating voltage of 4.52 V and 45° C. normalized to the first cycle, in accordance with an illustrative embodiment;

FIG. 6D depicts the RSS at 20% SoC as a function of cycle count for Electrolyte Fluid 1 and Electrolyte Fluid 2 in a battery cell at an operating voltage of 4.52V and 45° C., in accordance with an illustrative embodiment;

FIG. 7A depicts the discharge capacity as a function of cycle count for Electrolyte Fluid 2 in a battery cell having a blended cathode of 70 wt % LCO and 30 wt % NMC, and operating at 4.52V, in accordance with an illustrative embodiment, in accordance with an illustrative embodiment;

FIG. 7B depicts the energy retention normalized to the first cycle as a function of cycle count for Electrolyte Fluid 2 in a battery cell having a blended cathode of 70 wt % LCO and 30 wt % NMC, and operating at 4.52V, in accordance with an illustrative embodiment;

FIG. 7C depicts the direct current internal resistance (DCIR) at 20% SoC as a function of cycle count for Electrolyte Fluid 2 in a battery cell having a blended cathode of 70 wt % LCO and 30 wt % NMC, and operating at 4.52V, in accordance with an illustrative embodiment;

FIG. 8A depicts the specific discharge capacity as a function of cycle count for Electrolyte Fluid 1 and Electrolyte Fluid 2 in a battery cell operating at 4.52V and 45° C., in accordance with an illustrative embodiment;

FIG. 8B depicts energy retention as a function of cycle count for Electrolyte Fluid 1 and Electrolyte Fluid 2 in a battery cell operating at 4.52V and 45° C., in accordance with an illustrative embodiment;

FIG. 8C depicts the RSS at 20% SoC as a function of cycle count for Electrolyte Fluid 1 and Electrolyte Fluid 2 in a battery cell operating at 4.52V and 45° C., in accordance with an illustrative embodiment;

FIG. 9A depicts the specific discharge capacity as a function of cycle count for Electrolyte Fluid 3 and Electrolyte Fluid 4 in a battery cell operating at 4.52V and 25° C., in accordance with an illustrative embodiment; and

FIG. 9B depicts energy retention as a function of cycle count for Electrolyte Fluid 3 and Electrolyte Fluid 4 in a battery cell having a blended cathode and operating at 4.52V and 45° C., in accordance with an illustrative embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

FIG. 1 presents a top-down view of a battery cell 100 in accordance with an illustrative embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between the cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

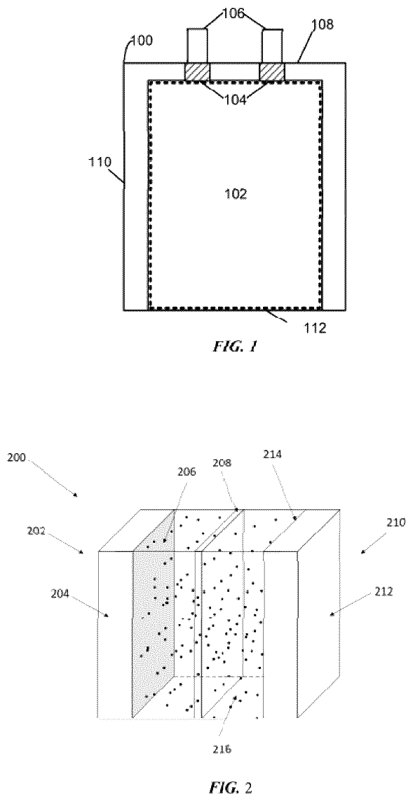

FIG. 2 presents a perspective view of battery cell 200 (e.g., the battery cell 100 of FIG. 1) in accordance with the disclosed illustrative embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210, and is in contact with separator 208. To create the battery cell, cathode 202, separator 208, and anode 210 may be stacked in a planar configuration, or stacked and then wrapped into a wound configuration. The Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil. The cathode active material can be any material, or combination of materials, described in, for example, Ser. No. 14/206,654, 15/458,604, 15/458,612, 15/709,961, 15/710,540, 15/804,186, 16/531,883, 16/529,545, 16/999,307, 16/999,328, 16/999,265, and/or 18/798,661, each of which is incorporated herein by reference in its entirety.

As described herein, a blended cathode (used interchangeably with blended cathode active material) refers to a cathode or cathode active material including a first cathode active material comprising lithium, cobalt, and oxygen (LCO), and a second cathode active material comprising lithium, cobalt, nickel, manganese, and oxygen (NMC). Such cathode active materials may be any material or combination of materials described herein. In some variations, the cathode active material includes NMC 65:28:7 in an 80:20 ratio with LCO. In other variations, the cathode active material includes NMC 65:10:25 in a 70:30 ratio with LCO.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (Pad). Other microporous polymer membranes or non-woven fabric mats are possible (e.g., gel polymer electrolytes).

In general, separators represent structures in a battery, such as interposed layers, that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, electrolyte fluid can act a conductive pathway for the movement of cations passing from the negative to the positive electrodes during discharge. The electrolyte fluid includes an electrolyte salt, a solvent, and one or more electrolyte additives.

The disclosure is directed to electrolyte fluids having solvents that include dimethyl carbonate (DMC) and ethylmethylcarbonate (EMC). The addition of DMC and EMC to the electrolyte solvent can result in increased discharge capacity, increased energy retention, and reduced internal resistance, particularly at increased cycle counts.

The combined quantity of DMC and EMC can have a lower boundary and/or an upper boundary. In one variation, the combined quantity of DMC and EMC is at least 50% of the total electrolyte fluid. In another variation, the combined quantity of DMC and EMC is at least 55% of the total electrolyte fluid. In another variation, the combined quantity of DMC and EMC is at least 60% of the total electrolyte fluid. In another variation, the combined quantity of DMC and EMC is at least 65% of the total electrolyte fluid. In another variation, the combined quantity of DMC and EMC is at least 70% of the total electrolyte fluid. In another variation, the combined quantity of DMC and EMC is at least 75% of the total electrolyte fluid.

In another variation, the combined quantity of DMC and EMC is less than or equal to 80 wt % of the total electrolyte fluid. In another variation, the combined quantity of DMC and EMC is less than or equal to 80 wt % of the total electrolyte fluid. In another variation, the combined quantity of DMC and EMC is less than or equal to 75 wt % of the total electrolyte fluid. In another variation, the combined quantity of DMC and EMC is less than or equal to 70 wt % of the total electrolyte fluid. In another variation, the combined quantity of DMC and EMC is less than or equal to 65 wt % of the total electrolyte fluid. In another variation, the combined quantity of DMC and EMC is less than or equal to 60 wt % of the total electrolyte fluid. In another variation, the combined quantity of DMC and EMC is less than or equal to 55 wt % of the total electrolyte fluid.

The combined quantity of DMC and EMC can have a lower boundary and/or upper boundary in any combination. In some variations, the combined quantity of DMC and EMC is 50 wt %-80 wt % of the electrolyte fluid.

In one variation, the wt % ratio of DMC:EMC is at least 1:4. In one variation, the wt % ratio of DMC:EMC is at least 1:3. In another variation, the wt % ratio of DMC:EMC is at least 1:2. In another variation, the wt % ratio of DMC:EMC is at least 1:1. In one variation, the wt % ratio of DMC:EMC is at least 2:1. In another variation, the wt % ratio of DMC:EMC is at least 3:1.

In other variations, the wt % ratio of DMC:EMC is less than or equal to 4:1. In another variation, the wt % ratio of DMC:EMC is less than or equal to 3:1. In another variation, the wt % ratio of DMC:EMC is less than or equal to 2:1. In another variation, the wt % ratio of DMC:EMC is less than or equal to 1:1. In another variation, the wt % ratio of DMC:EMC is less than or equal to 1:2. In another variation, the wt % ratio of DMC:EMC is less than or equal to 1:3.

The wt % ratio of DMC:EMC can have a lower boundary and/or upper boundary in any combination. In one variation, the wt % ratio of DMC:EMC is from 1:4::4:1.

In some variations, DMC is an amount of at least 10 wt % of the total electrolyte fluid. In some variations, DMC is an amount of at least 20 wt % of the total electrolyte fluid. In some variations, DMC is an amount of at least 30 wt % of the total electrolyte fluid. In some variations, DMC is an amount of at least 40 wt % of the total electrolyte fluid. In some variations, DMC is an amount of at least 50 wt % of the total electrolyte fluid. In some variations, DMC is an amount of at least 60 wt % of the total electrolyte fluid.

In some variations, DMC is less than or equal to 70 wt % of the total electrolyte fluid. In some variations, DMC is less than or equal to 60 wt % of the total electrolyte fluid. In some variations, DMC is less than or equal to 50 wt % of the total electrolyte fluid. In some variations, DMC is less than or equal to 40 wt % of the total electrolyte fluid. In some variations, DMC is less than or equal to 30 wt % of the total electrolyte fluid. In some variations, DMC is less than or equal to 20 wt % of the total electrolyte fluid.

The wt % of DMC can have a lower boundary and/or upper boundary in any combination as described herein.

In some variations, EMC is an amount of at least 10 wt % of the total electrolyte fluid. In some variations, EMC is an amount of at least 20 wt % of the total electrolyte fluid. In some variations, EMC is an amount of at least 30 wt % of the total electrolyte fluid. In some variations, EMC is an amount of at least 40 wt % of the total electrolyte fluid. In some variations, EMC is an amount of at least 50 wt % of the total electrolyte fluid. In some variations, EMC is an amount of at least 60 wt % of the total electrolyte fluid.

In some variations, EMC is less than or equal to 70 wt % of the total electrolyte fluid. In some variations, EMC is less than or equal to 60 wt % of the total electrolyte fluid. In some variations, EMC is less than or equal to 50 wt % of the total electrolyte fluid. In some variations, EMC is less than or equal to 40 wt % of the total electrolyte fluid. In some variations, EMC is less than or equal to 30 wt % of the total electrolyte fluid. In some variations, EMC is less than or equal to 20 wt % of the total electrolyte fluid.

The wt % of EMC can have a lower boundary and/or upper boundary in any combination as described herein.

In additional variations, the electrolyte solvent can include PC and EC.

In some variations, PC is an amount of at least 2 wt % of the total electrolyte fluid. In some variations, PC is an amount of at least 5 wt % of the total electrolyte fluid. In some variations, PC is an amount of at least 10 wt % of the total electrolyte fluid. In some variations, PC is an amount of at least 15 wt % of the total electrolyte fluid.

In some variations, PC is less than or equal to 20 wt % of the total electrolyte fluid. In some variations, PC is less than or equal to 15 wt % of the total electrolyte fluid. In some variations, PC is less than or equal to 10 wt % of the total electrolyte fluid. In some variations, PC is less than or equal to 5 wt % of the total electrolyte fluid.

The wt % of PC can have a lower boundary and/or upper boundary in any combination as described herein.

In some variations, EC is an amount of at least 2 wt % of the total electrolyte fluid. In some variations, EC is an amount of at least 5 wt % of the total electrolyte fluid. In some variations, EC is an amount of at least 10 wt % of the total electrolyte fluid. In some variations, EC is an amount of at least 15 wt % of the total electrolyte fluid.

In some variations, EC is less than or equal to 20 wt % of the total electrolyte fluid. In some variations, EC is less than or equal to 15 wt % of the total electrolyte fluid. In some variations, EC is less than or equal to 10 wt % of the total electrolyte fluid. In some variations, EC is less than or equal to 5 wt % of the total electrolyte fluid.

The wt % of EC can have a lower boundary and/or upper boundary in any combination as described herein.

In further variations, the solvent can be FEC, as described above.

In further variations, the solvent can include ethyl propionate (EP) and propyl propionate (PP).

In some variations, EP is an amount of at least 2 wt % of the total electrolyte fluid. In some variations, EP is an amount of at least 5 wt % of the total electrolyte fluid. In some variations, EP is an amount of at least 10 wt % of the total electrolyte fluid. In some variations, EP is an amount of at least 15 wt % of the total electrolyte fluid.

In some variations, EP is less than or equal to 20 wt % of the total electrolyte fluid. In some variations, EP is less than or equal to 15 wt % of the total electrolyte fluid. In some variations, EP is less than or equal to 10 wt % of the total electrolyte fluid. In some variations, EP is less than or equal to 5 wt % of the total electrolyte fluid.

The wt % of EP can have a lower boundary and/or upper boundary in any combination as described herein.

In some variations, PP is an amount of at least 2 wt % of the total electrolyte fluid. In some variations, PP is an amount of at least 5 wt % of the total electrolyte fluid. In some variations, PP is an amount of at least 10 wt % of the total electrolyte fluid. In some variations, PP is an amount of at least 15 wt % of the total electrolyte fluid.

In some variations, PP is less than or equal to 20 wt % of the total electrolyte fluid. In some variations, PP is less than or equal to 15 wt % of the total electrolyte fluid. In some variations, PP is less than or equal to 10 wt % of the total electrolyte fluid. In some variations, PP is less than or equal to 5 wt % of the total electrolyte fluid.

The wt % of PP can have a lower boundary and/or upper boundary in any combination as described herein.

The electrolyte fluid also has one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and any combinations thereof. Other salts are possible, including combinations of salts.

In some variations, the salt is at least 0.1 M in the total electrolyte fluid. In some variations, the salt is at least 0.2 M in the total electrolyte fluid. In some variations, the salt is at least 0.3 M in the total electrolyte fluid. In some variations, the salt is at least 0.4 M in the total electrolyte fluid. In some variations, the salt is at least 0.5 M in the total electrolyte fluid. In some variations, the salt is at least 0.6 M in the total electrolyte fluid. In some variations, the salt is at least 0.7 M in the total electrolyte fluid. In some variations, the salt is at least 0.8 M in the total electrolyte fluid. In some variations, the salt is at least 0.9 M in the total electrolyte fluid. In some variations, the salt is at least 1.0 M in the total electrolyte fluid. In some variations, the salt is at least 1.3 M in the total electrolyte fluid. In some variations, the salt is at least 1.6 M in the total electrolyte fluid. In some variations, the salt is at least 1.9 M in the total electrolyte fluid.

In some variations, the salt is less than or equal to 2.0 M in the electrolyte fluid. In some variations, the salt is less than or equal to 1.9 M in the electrolyte fluid. In some variations, the salt is less than or equal to 1.6 M in the electrolyte fluid. In some variations, the salt is less than or equal to 1.3 M in the electrolyte fluid. In some variations, the salt is less than or equal to 1.1 M in the electrolyte fluid. In some variations, the salt is less than or equal to 1.0 M in the electrolyte fluid. In some variations, the salt is less than or equal to 0.9 M in the electrolyte fluid. In some variations, the salt is less than or equal to 0.8 M in the electrolyte fluid. In some variations, the salt is less than or equal to 0.7 M in the electrolyte fluid. In some variations, the salt is less than or equal to 0.6 M in the electrolyte fluid. In some variations, the salt is less than or equal to 0.5 M in the electrolyte fluid. In some variations, the salt is less than or equal to 0.4 M in the electrolyte fluid. In some variations, the salt is less than or equal to 0.3 M in the electrolyte fluid. In some variations, the salt is less than or equal to 0.2 M in the electrolyte fluid.

In further variations, the electrolyte fluid can include additional additives. In non-limiting variations, the additives can include lithium difluoro(oxalato)borate (LiDFOB), succinonitrile (SN), fluoroethylene carbonate (FEC), propane sultone (PS), and/or 1,3,6-hexanetricarbonitrile (HTCN), and any combination thereof.

In some variations, the electrolyte fluid can include LiDFOB. LiDFOB is at least 0.1 wt % of the total electrolyte fluid. In some variations, LiDFOB is at least 0.2 wt % of the total electrolyte fluid. In some variations, LiDFOB is at least 0.3 wt % of the total electrolyte fluid. In some variations, LiDFOB is at least 0.4 wt % of the total electrolyte fluid. In some variations, LiDFOB is at least 0.5 wt % of the total electrolyte fluid. In some variations, LiDFOB is at least 0.6 wt % of the total electrolyte fluid. In some variations, LiDFOB is at least 0.7 wt % of the total electrolyte fluid. In some variations, LiDFOB is at least 0.8 wt % of the total electrolyte fluid. In some variations, LiDFOB is at least 0.9 wt % of the total electrolyte fluid. In some variations, LiDFOB is at least 1.0 wt % of the total electrolyte fluid. In some variations, LiDFOB is at least 1.3 wt % of the total electrolyte fluid. In some variations, LiDFOB is at least 1.6 wt % of the total electrolyte fluid. In some variations, LiDFOB is at least 1.9 wt % of the total electrolyte fluid. In some variations, LiDFOB is at least 2.0 wt % of the total electrolyte fluid. In some variations, LiDFOB is at least 2.3 wt % of the total electrolyte fluid. In some variations, LiDFOB is at least 2.6 wt % of the total electrolyte fluid. In some variations, LiDFOB is at least 2.9 wt % of the total electrolyte fluid.

In some variations, LiDFOB is less than or equal to 3.0 wt % of the total electrolyte fluid. In some variations, LiDFOB is less than or equal to 2.9 wt % of the total electrolyte fluid. In some variations, LiDFOB is less than or equal to 2.6 wt % of the total electrolyte fluid. In some variations, LiDFOB is less than or equal to 2.3 wt % of the total electrolyte fluid. In some variations, LiDFOB is less than or equal to 2.0 wt % of the total electrolyte fluid. In some variations, LiDFOB is less than or equal to 1.9 wt % of the total electrolyte fluid. In some variations, LiDFOB is less than or equal to 1.3 wt % of the total electrolyte fluid. In some variations, LiDFOB is less than or equal to 1.3 wt % of the total electrolyte fluid. In some variations, LiDFOB is less than or equal to 1.1 wt % of the total electrolyte fluid. In some variations, LiDFOB is less than or equal to 1.0 wt % of the total electrolyte fluid. In some variations, LiDFOB is less than or equal to 0.9 wt % of the total electrolyte fluid. In some variations, LiDFOB is less than or equal to 0.8 wt % of the total electrolyte fluid. In some variations, LiDFOB is less than or equal to 0.7 wt % of the total electrolyte fluid. In some variations, LiDFOB is less than or equal to 0.6 wt % of the total electrolyte fluid. In some variations, LiDFOB is less than or equal to 0.5 wt % of the total electrolyte fluid. In some variations, LiDFOB is less than or equal to 0.4 wt % of the total electrolyte fluid. In some variations, LiDFOB is less than or equal to 0.3 wt % of the total electrolyte fluid. In some variations, LiDFOB is less than or equal to 0.2 wt % of the total electrolyte fluid.

LiDFOB can be present in a lower boundary, upper boundary, or both. The upper and lower boundaries of the LiDFOB quantity as described herein can be chosen in any combination.

In some variations, the amount of SN is at least 0.5 wt % of the total electrolyte fluid. In some variations, the amount of SN is at least 1.0 wt % of the total electrolyte fluid. In some variations, the amount of SN is at least 1.5 wt % of the total electrolyte fluid. In some variations, the amount of SN is at least 2.0 wt % of the total electrolyte fluid. In some variations, the amount of SN is at least 2.5 wt % of the total electrolyte fluid. In some variations, the amount of SN is at least 3.0 wt % of the total electrolyte fluid. In some variations, the amount of SN is at least 3.5 wt % of the total electrolyte fluid. In some variations, the amount of SN is at least 4.0 wt % of the total electrolyte fluid. In some variations, the amount of SN is at least 4.5 wt % of the total electrolyte fluid. In some variations, the amount of SN is at least 5.0 wt % of the total electrolyte fluid.

In some variations, the amount of SN is less than or equal to 6.0 wt % of the total electrolyte fluid. In some variations, the amount of SN is less than or equal to 5.5 wt % of the total electrolyte fluid. In some variations, the amount of SN is less than or equal to 5.0 wt % of the total electrolyte fluid. In some variations, the amount of SN is less than or equal to 4.5 wt % of the total electrolyte fluid. In some variations, the amount of SN is less than or equal to 4.0 wt % of the total electrolyte fluid. In some variations, the amount of SN is less than or equal to 3.5 wt % of the total electrolyte fluid. In some variations, the amount of SN is less than or equal to 3.0 wt % of the total electrolyte fluid. In some variations, the amount of SN is less than or equal to 2.5 wt % of the total electrolyte fluid. In some variations, the amount of SN is less than or equal to 2.0 wt % of the total electrolyte fluid. In some variations, the amount of SN is less than or equal to 1.5 wt % of the total electrolyte fluid. In some variations, the amount of SN is less than or equal to 1.0 wt % of the total electrolyte fluid.

SN can be present in a lower boundary, upper boundary, or both. The upper and lower boundaries of the SN quantity as described herein can be chosen in any combination.

In some variations, the electrolyte fluid can include FEC. In some variations, the amount of FEC is at least 0.5 wt % of the total electrolyte fluid. In some variations, the amount of FEC is at least 1.5 wt % of the total electrolyte fluid. In some variations, the amount of FEC is at least 2.0 wt % of the total electrolyte fluid. In some variations, the amount of FEC is at least 2.5 wt % of the total electrolyte fluid. In some variations, the amount of FEC is at least 3.0 wt % of the total electrolyte fluid. In some variations, the amount of FEC is at least 3.5 wt % of the total electrolyte fluid. In some variations, the amount of FEC is at least 4.0 wt % of the total electrolyte fluid. In some variations, the amount of FEC is at least 4.5 wt % of the total electrolyte fluid. In some variations, the amount of FEC is at least 5.0 wt % of the total electrolyte fluid. In some variations, the amount of FEC is at least 5.5 wt % of the total electrolyte fluid. In some variations, the amount of FEC is at least 6.5 wt % of the total electrolyte fluid. In some variations, the amount of FEC is at least 7.0 wt % of the total electrolyte fluid. In some variations, the amount of FEC is at least 7.5 wt % of the total electrolyte fluid. In some variations, the amount of FEC is at least 8.0 wt % of the total electrolyte fluid. In some variations, the amount of FEC is at least 8.5 wt % of the total electrolyte fluid. In some variations, the amount of FEC is at least 9.0 wt % of the total electrolyte fluid. In some variations, the amount of FEC is at least 9.5 wt % of the total electrolyte fluid. In some variations, the amount of FEC is at least 10.0 wt % of the total electrolyte fluid. In some variations, the amount of FEC is at least 10.5 wt % of the total electrolyte fluid. In some variations, the amount of FEC is at least 11.0 wt % of the total electrolyte fluid. In some variations, the amount of FEC is at least 11.5 wt % of the total electrolyte fluid. In some variations, the amount of FEC is at least 11.0 wt % of the total electrolyte fluid. In some variations, the amount of FEC is at least 11.5 wt % of the total electrolyte fluid. In some variations, the amount of FEC is at least 12.0 wt % of the total electrolyte fluid. In some variations, the amount of FEC is at least 12.5 wt % of the total electrolyte fluid. In some variations, the amount of FEC is at least 13.0 wt % of the total electrolyte fluid. In some variations, the amount of FEC is at least 13.5 wt % of the total electrolyte fluid. In some variations, the amount of FEC is at least 14.0 wt % of the total electrolyte fluid. In some variations, the amount of FEC is at least 14.5 wt % of the total electrolyte fluid.

In some variations, the amount of FEC is less than or equal to 15.0 wt % of the total electrolyte fluid. In some variations, the amount of FEC is less than or equal to 14.5 wt % of the total electrolyte fluid. In some variations, the amount of FEC is less than or equal to 14.0 wt % of the total electrolyte fluid. In some variations, the amount of FEC is less than or equal to 13.5 wt % of the total electrolyte fluid. In some variations, the amount of FEC is less than or equal to 13.0 wt % of the total electrolyte fluid. In some variations, the amount of FEC is less than or equal to 12.5 wt % of the total electrolyte fluid. In some variations, the amount of FEC is less than or equal to 12.0 wt % of the total electrolyte fluid. In some variations, the amount of FEC is less than or equal to 11.5 wt % of the total electrolyte fluid. In some variations, the amount of FEC is less than or equal to 11.0 wt % of the total electrolyte fluid. In some variations, the amount of FEC is less than or equal to 10.5 wt % of the total electrolyte fluid. In some variations, the amount of FEC is less than or equal to 10.0 wt % of the total electrolyte fluid. In some variations, the amount of FEC is less than or equal to 9.5 wt % of the total electrolyte fluid. In some variations, the amount of FEC is less than or equal to 9.0 wt % of the total electrolyte fluid. In some variations, the amount of FEC is less than or equal to 8.5 wt % of the total electrolyte fluid. In some variations, the amount of FEC is less than or equal to 8.0 wt % of the total electrolyte fluid. In some variations, the amount of FEC is less than or equal to 7.5 wt % of the total electrolyte fluid. In some variations, the amount of FEC is less than or equal to 7.0 wt % of the total electrolyte fluid. In some variations, the amount of FEC is less than or equal to 6.5 wt % of the total electrolyte fluid. In some variations, the amount of FEC is less than or equal to 6.0 wt % of the total electrolyte fluid. In some variations, the amount of FEC is less than or equal to 5.5 wt % of the total electrolyte fluid. In some variations, the amount of FEC is less than or equal to 5.0 wt % of the total electrolyte fluid. In some variations, the amount of FEC is less than or equal to 4.5 wt % of the total electrolyte fluid. In some variations, the amount of FEC is less than or equal to 4.0 wt % of the total electrolyte fluid. In some variations, the amount of FEC is less than or equal to 3.5 wt % of the total electrolyte fluid. In some variations, the amount of FEC is less than or equal to 3.0 wt % of the total electrolyte fluid. In some variations, the amount of FEC is less than or equal to 2.5 wt % of the total electrolyte fluid. In some variations, the amount of FEC is less than or equal to 2.0 wt % of the total electrolyte fluid. In some variations, the amount of FEC is less than or equal to 1.5 wt % of the total electrolyte fluid. In some variations, the amount of FEC is less than or equal to 1.0 wt % of the total electrolyte fluid.

FEC can be present in a lower boundary, upper boundary, or both. The upper and lower boundaries of the FEC quantity as described herein can be chosen in any combination.

In some variations, the amount of PS is at least 0.5 wt % of the total electrolyte fluid. In some variations, the amount of PS is at least 1.0 wt % of the total electrolyte fluid. In some variations, the amount of PS is at least 1.5 wt % of the total electrolyte fluid. In some variations, the amount of PS is at least 2.0 wt % of the total electrolyte fluid. In some variations, the amount of PS is at least 2.5 wt % of the total electrolyte fluid. In some variations, the amount of PS is at least 3.0 wt % of the total electrolyte fluid. In some variations, the amount of PS is at least 3.5 wt % of the total electrolyte fluid. In some variations, the amount of PS is at least 4.0 wt % of the total electrolyte fluid. In some variations, the amount of PS is at least 4.5 wt % of the total electrolyte fluid. In some variations, the amount of PS is at least 5.0 wt % of the total electrolyte fluid. In some variations, the amount of PS is at least 5.5 wt % of the total electrolyte fluid. In some variations, the amount of PS is at least 6.0 wt % of the total electrolyte fluid. in some variations, the amount of PS is at least 6.5 wt % of the total electrolyte fluid. In some variations, the amount of PS is at least 7.0 wt % of the total electrolyte fluid. In some variations, the amount of PS is at least 7.5 wt % of the total electrolyte fluid.

In some variations, the amount of PS is less than or equal to 8.0 wt % of the total electrolyte fluid. In some variations, the amount of PS is less than or equal to 7.5 wt % of the total electrolyte fluid. In some variations, the amount of PS is less than or equal to 7.0 wt % of the total electrolyte fluid. In some variations, the amount of PS is less than or equal to 6.5 wt % of the total electrolyte fluid. In some variations, the amount of PS is less than or equal to 6.0 wt % of the total electrolyte fluid. In some variations, the amount of PS is less than or equal to 5.5 wt % of the total electrolyte fluid. In some variations, the amount of PS is less than or equal to 5.0 wt % of the total electrolyte fluid. In some variations, the amount of PS is less than or equal to 4.5 wt % of the total electrolyte fluid. In some variations, the amount of PS is less than or equal to 4.0 wt % of the total electrolyte fluid. In some variations, the amount of PS is less than or equal to 3.5 wt % of the total electrolyte fluid. In some variations, the amount of PS is less than or equal to 3.0 wt % of the total electrolyte fluid. In some variations, the amount of PS is less than or equal to 2.5 wt % of the total electrolyte fluid. In some variations, the amount of PS is less than or equal to 2.0 wt % of the total electrolyte fluid. In some variations, the amount of PS is less than or equal to 1.5 wt % of the total electrolyte fluid. In some variations, the amount of PS is less than or equal to 1.0 wt % of the total electrolyte fluid.

PS can be present in a lower boundary, upper boundary, or both. The upper and lower boundaries of the PS quantity as described herein can be chosen in any combination.

In some variations, the amount of HTCN is at least 0.5 wt % of the total electrolyte fluid. In some variations, the amount of HTCN is at least 1.0 wt % of the total electrolyte fluid. In some variations, the amount of HTCN is at least 1.5 wt % of the total electrolyte fluid. In some variations, the amount of HTCN is at least 2.0 wt % of the total electrolyte fluid. In some variations, the amount of HTCN is at least 2.5 wt % of the total electrolyte fluid. In some variations, the amount of HTCN is at least 3.0 wt % of the total electrolyte fluid. In some variations, the amount of HTCN is at least 3.5 wt % of the total electrolyte fluid. In some variations, the amount of HTCN is at least 4.0 wt % of the total electrolyte fluid. In some variations, the amount of HTCN is at least 4.5 wt % of the total electrolyte fluid. In some variations, the amount of HTCN is at least 5.0 wt % of the total electrolyte fluid.

In some variations, the amount of HTCN is less than or equal to 6.0 wt % of the total electrolyte fluid. In some variations, the amount of HTCN is less than or equal to 5.5 wt % of the total electrolyte fluid. In some variations, the amount of HTCN is less than or equal to 5.0 wt % of the total electrolyte fluid. In some variations, the amount of HTCN is less than or equal to 4.5 wt % of the total electrolyte fluid. In some variations, the amount of HTCN is less than or equal to 4.0 wt % of the total electrolyte fluid. In some variations, the amount of HTCN is less than or equal to 3.5 wt % of the total electrolyte fluid. In some variations, the amount of HTCN is less than or equal to 3.0 wt % of the total electrolyte fluid. In some variations, the amount of HTCN is less than or equal to 2.5 wt % of the total electrolyte fluid. In some variations, the amount of HTCN is less than or equal to 2.0 wt % of the total electrolyte fluid. In some variations, the amount of HTCN is less than or equal to 1.5 wt % of the total electrolyte fluid. In some variations, the amount of HTCN is less than or equal to 1.0 wt % of the total electrolyte fluid.

HTCN can be present in a lower boundary, upper boundary, or both. The upper and lower boundaries of the HTCN quantity as described herein can be chosen in any combination.

### EXAMPLES

The Examples are provided for illustration purposes only. These examples are not intended to constrain any embodiment disclosed herein to any application or theory of operation.

### Example 1

Tables 1A and 1B shows a series of electrolyte compositions. The difference between Electrolyte Fluid 1 and Electrolyte Fluid 2 is that DMC and EMC substitute for PP and EP, respectively.

TABLE 1A

| Electrolyte | LiPF6 | EC | PC | PP | EP | DMC | EMC |
|---|---|---|---|---|---|---|---|
| Fluid No. | (M) | (wt %) | (wt %) | (wt %) | (wt %) | (wt %) | (wt %) |
| 1 | 1.2 | 20 | 10 | 45 | 25 | | |
| 2 | 1.2 | 20 | 10 | | | 45 | 25 |

TABLE 1B

| Electrolyte Fluid No. | LiDFOB | SN | FEC | PS | HTCN |
|---|---|---|---|---|---|
| 1 | 0.5 | 2 | 7 | 4 | 3 |
| 2 | 0.5 | 2 | 7 | 4 | 3 |

In high voltage applications (e.g., applications in which the battery cell is at least 4.50 V), battery cell components degrade over cycling. As a result, the discharge capacity and energy retention fall over time.

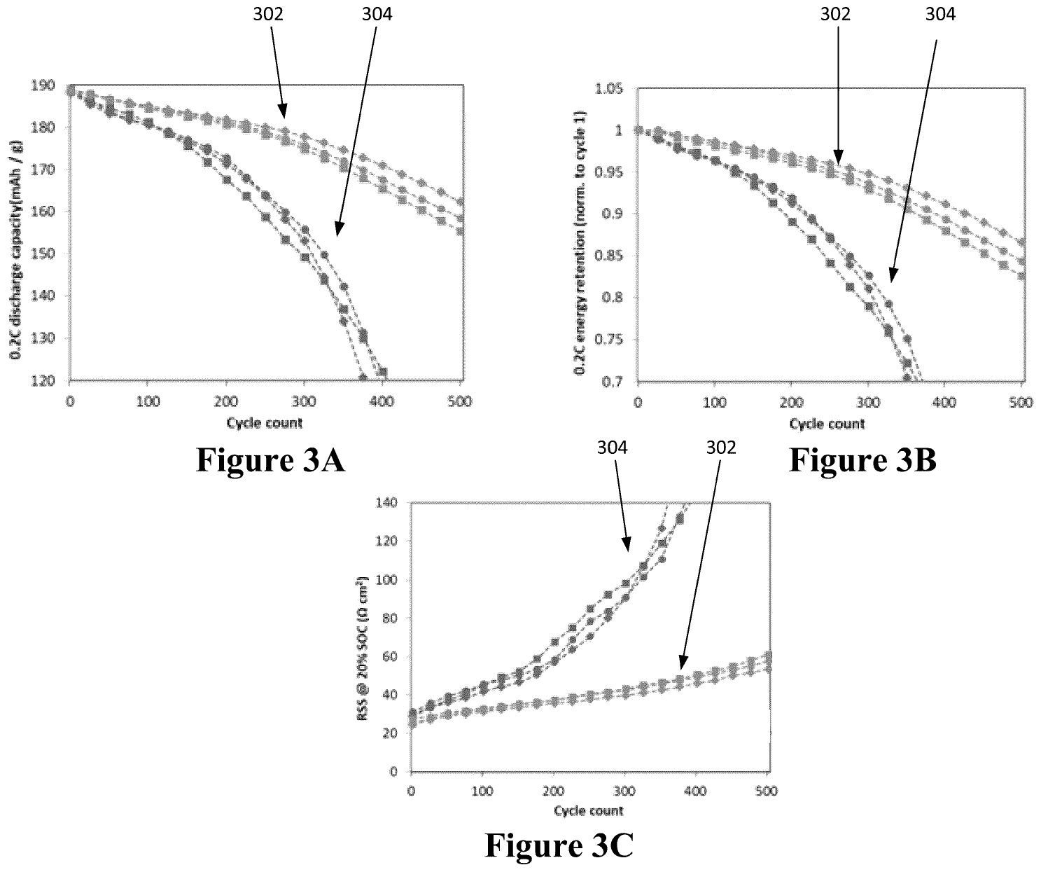

FIGS. 3A, 3B, and 3C show the discharge capacity, energy retention, and internal resistance (RSS) at 20% state of charge (SoC), respectively, as a function of cycle count for Electrolyte Fluid 1 (302) and Electrolyte Fluid 2 (304). Electrolyte Fluid 1 (302) includes dimethyl carbonate (DMC) and ethylmethylcarbonate (EMC) in the solvent along with propylene carbonate (PC) and ethylene carbonate (EC), while Electrolyte Fluid 2 (304) includes ethyl propionate (EP) and propyl propionate (PP) in the solvent alongside propylene carbonate (PC) and ethylene carbonate (EC).

With reference to FIG. 3A, the discharge capacity as a function of cycle count dramatically improved with the substitution of EMC and DMC (Electrolyte Fluid 2) in place of EP and PP (Electrolyte Fluid 1). Likewise, with reference to FIG. 3B, the energy retention as a function of cycle count dramatically improved with the substitution of EMC and DMC (Electrolyte Fluid 2) in place of EP and PP (Electrolyte Fluid 1). With reference to FIG. 3C, the internal resistance as a function of cycle count as a function of cycle dramatically decreases substantially with the substitution of EMC and DMC (Electrolyte Fluid 2) in place of EP and PP (Electrolyte Fluid 1).

Table 2 provides measurement for each of Electrolyte Fluid 1 and Electrolyte Fluid 2 of first cycle capacity, second cycle RSS, 25° C. formation capacity and formation RSS, and 85° C. first cycle storage recovery capacity and third cycle storage recovery capacity. Under operation at 25° C., the second cycle RSS for Electrolyte Fluid 2 was lower, and the formation capacity was higher. Further, the storage first cycle and storage third cycle capacity were both higher for Electrolyte Fluid 2 than for Electrolyte Fluid 1 at 85° C.

TABLE 2

| | | | 25° C. | | | |
|---|---|---|---|---|---|---|
| | 1st Cycle | | Formation | 25° C. | 85° C. Storage | 85° C. Storage |
| Electrolyte | capacity, | 2nd Cycle | capacity, | Formation | 1st cycle | 3rd cycle |
| Fluid | mAh/g | RSS, Ω cm² | mAh/g | RSS, Ω cm² | Recov cap % | Recov cap % |
| 1 | 188.4 ± 0.3 | 30.0 ± 1.2 | 182.9 ± 1.3 | 65.5 ± 3.8 | 94.5 ± 0.8 | 95.1 ± 0.8 |
| 2 | 188.7 ± 0.2 | 25.9 ± 1.7 | 183.1 ± 1.5 | 57.6 ± 1.6 | 96.5 ± 0.6 | 98.0 ± 0.1 |

Table 3 provides for each of Electrolyte Fluid 1 and Electrolyte Fluid 2, the first and third recovery capacity at 85° C., the formation C/5 capacity at 25° C., and the formation RSS at 25° C. for a battery cell operating at 4.52 V. The 85° C. recovery capacity increased more than experimental error by substitution of DMC and EMC for PP and EP (Electrolyte 2), while all other electrolyte fluid components remained the same. The 25° C. formation C/5 capacity decreased significantly for Electrolyte Fluid 2.

TABLE 3

| | | | 25° C. | 25° C. |
|---|---|---|---|---|
| Electrolyte | 85° C. Recovered Cap % | | Formation C/5 | Formation |
| Fluid | Cycle 1 | Cycle 3 | capacity, mAh/g | RSS, Ω cm2 |
| 1 | 95.3 ± 0.2 | 95.5 ± 0.4 | 190.9 ± 0.3 | 61.8 ± 0.6 |
| 2 | 96.7 ± 0.2 | 97.9 ± 0.2 | 189.3 ± 0.6 | 56.0 ± 1.3 |

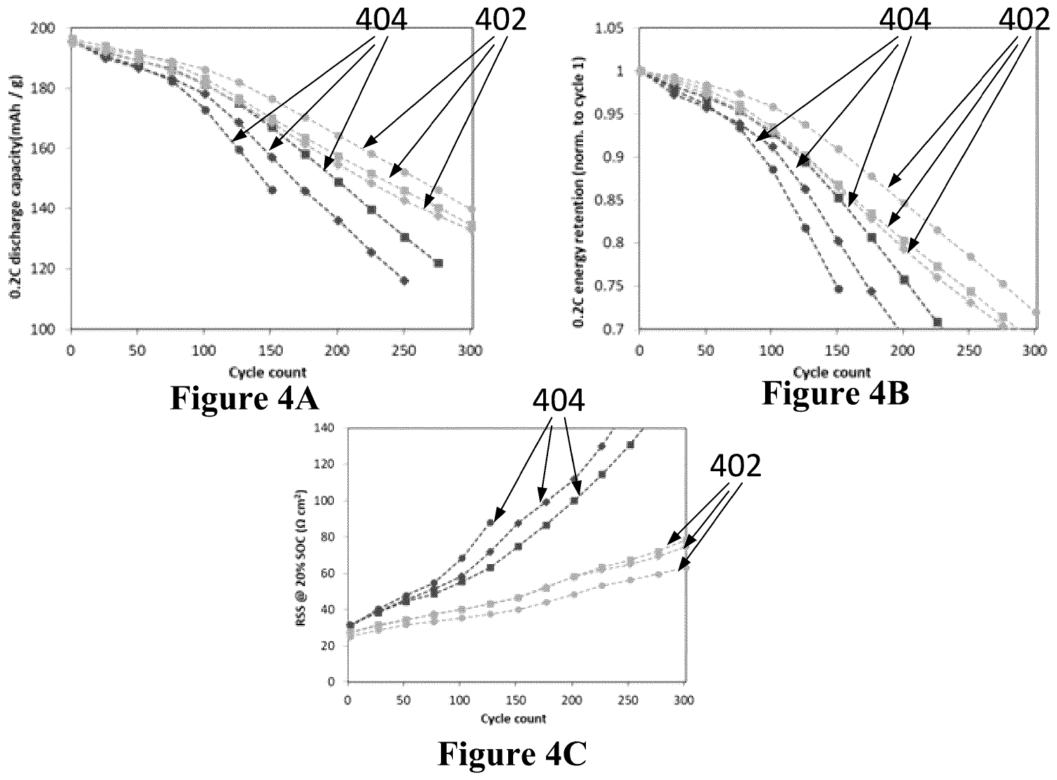

FIGS. 4A, 4B, and 4C depict the discharge capacity, energy retention, and internal resistance (RSS) at 20% state of charge (SoC), respectively, as a function of cycle count for Electrolyte Fluid 1 (402) and Electrolyte Fluid 2 (404) in a battery cell operating at 4.52V and 45° C. Electrolyte Fluid 1 (402) includes dimethyl carbonate (DMC) and ethylmethylcarbonate (EMC) in the solvent along with propylene carbonate (PC) and ethylene carbonate (EC), while Electrolyte Fluid 2 (304) includes ethyl propionate (EP) and propyl propionate (PP) in the solvent alongside propylene carbonate (PC) and ethylene carbonate (EC).

With reference to FIG. 4A, the discharge capacity as a function of cycle count dramatically improved with the substitution of EMC and DMC (Electrolyte Fluid 2, 402) in place of EP and PP (Electrolyte Fluid 1, 404). Likewise, with reference to FIG. 4B, the energy retention as a function of cycle count dramatically improved with the substitution of EMC and DMC (Electrolyte Fluid 2, 402) in place of EP and PP (Electrolyte Fluid 1, 404). With reference to FIG. 4C, the internal resistance as a function of cycle count as a function of cycle dramatically decreases substantially with the substitution of EMC and DMC (Electrolyte Fluid 2, 404) in place of EP and PP (Electrolyte Fluid 1, 402).

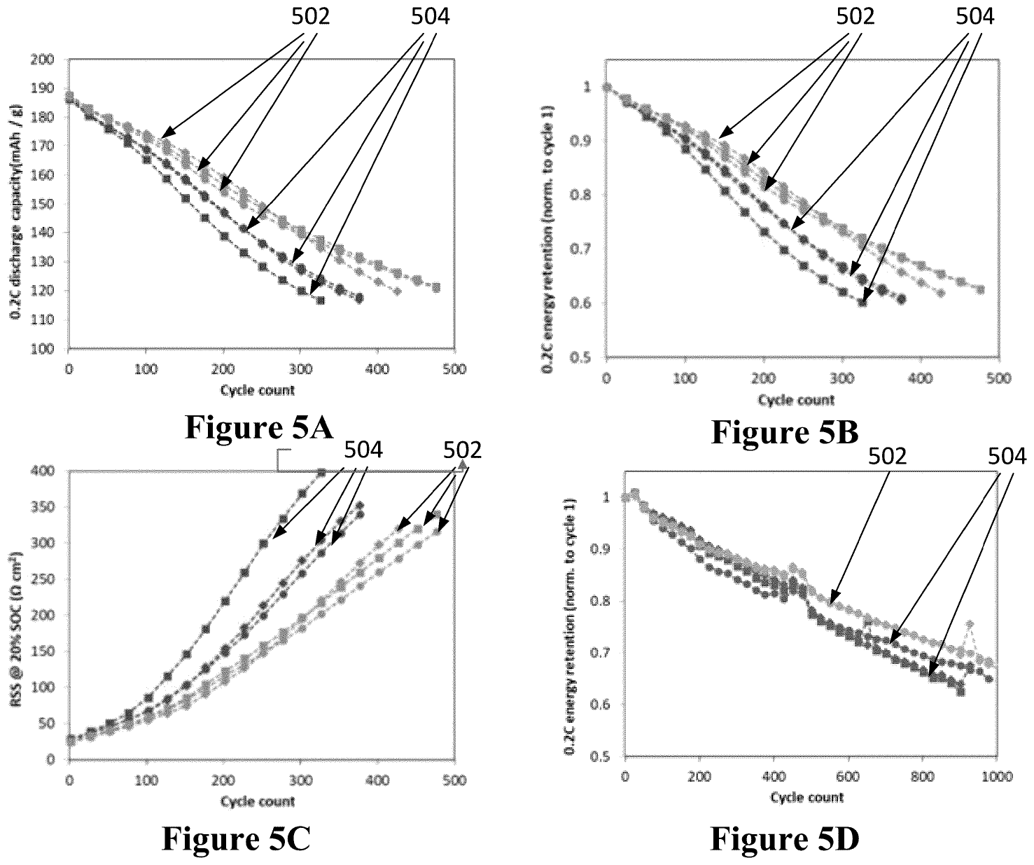

FIGS. 5A, 5B, and 5C depict the discharge capacity, energy retention, and internal resistance (RSS) at 20% state of charge (SoC), respectively, as a function of cycle count. Two electrolyte fluids were compared: Electrolyte Fluid 1 (504) and Electrolyte Fluid 2 (502) in a battery cell operating at 4.52V and 45° C., using a blended cathode. Electrolyte Fluid 1 (504) includes dimethyl carbonate (DMC) and ethylmethylcarbonate (EMC) in the solvent along with propylene carbonate (PC) and ethylene carbonate (EC), while Electrolyte Fluid 2 (502) includes ethyl propionate (EP) and propyl propionate (PP) in the solvent alongside propylene carbonate (PC) and ethylene carbonate (EC).

With reference to FIG. 5A, the discharge capacity as a function of cycle count dramatically improved with the substitution of EMC and DMC (Electrolyte Fluid 2, 504) in place of EP and PP (Electrolyte Fluid 1, 502). Likewise, with reference to FIG. 5B, the energy retention as a function of cycle count dramatically improved with the substitution of EMC and DMC (Electrolyte Fluid 2, 504) in place of EP and PP (Electrolyte Fluid 1, 502). With reference to FIG. 5C, the internal resistance as a function of cycle count as a function of cycle dramatically decreases substantially with the substitution of EMC and DMC (Electrolyte Fluid 2, 504) in place of EP and PP (Electrolyte Fluid 1, 502).

With reference to FIG. 5D, the energy retention as a function of cycle count is depicted for a battery cell containing Electrolyte Fluid 1 (504) and Electrolyte Fluid 2 (502), at an operating voltage of 4.52 V at 25° C. The energy retention as a function of cycle count dramatically improved with the substitution of EMC and DMC (Electrolyte Fluid 2, 504) in place of EP and PP (Electrolyte Fluid 1, 502).

FIGS. 5A-5D collectively show that substituting EMC and DMC in place of EP and PP in an electrolyte solvent results in improved battery performance over multiple high operating voltage limits and cathode active materials.

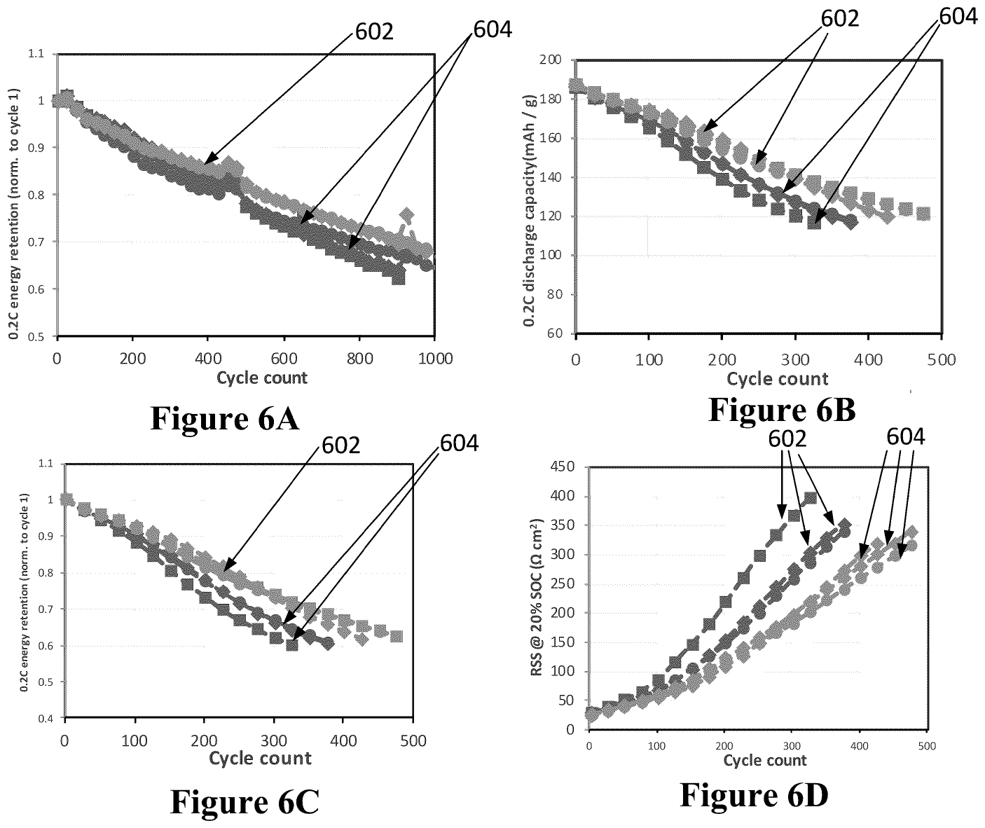

FIG. 6A depicts the energy retention as a function of cycle count of a battery cell containing Electrolyte Fluid 1 (604) and Electrolyte Fluid 2 (602) at an operating voltage of 4.52 V at 25° C. normalized to the first cycle. The energy retention as a function of cycle count improved with the substitution of EMC and DMC (Electrolyte Fluid 2, 604) in place of EP and PP (Electrolyte Fluid 1, 602).

FIG. 6B depicts the discharge capacity as a function of cycle count for Electrolyte Fluid 1 (602) and Electrolyte Fluid 2 (604) in a battery cell operating at an operating voltage of 4.52V at 45° C. The discharge capacity as a function of cycle count improved with the substitution of EMC and DMC (Electrolyte Fluid 2, 604) in place of EP and PP (Electrolyte Fluid 1, 602).

FIG. 6C depicts the energy retention as a function of cycle count of a battery cell containing Electrolyte Fluid 1 (604) and Electrolyte Fluid 2 (602) at an operating voltage of 4.52 V at 45° C. normalized to the first cycle. FIG. 6C, the energy retention as a function of cycle count improved with the substitution of EMC and DMC (Electrolyte Fluid 2, 604) in place of EP and PP (Electrolyte Fluid 1, 602).

FIG. 6D the internal resistance (RSS) at 20% state of charge (SoC) as a function of cycle count for Electrolyte Fluid 1 and Electrolyte Fluid 2 in a battery cell at an operating voltage of 4.52V at 45° C. The internal resistance as a function of cycle count as a function of cycle decreases with the substitution of EMC and DMC (Electrolyte Fluid 2, 604) in place of EP and PP (Electrolyte Fluid 1, 602).

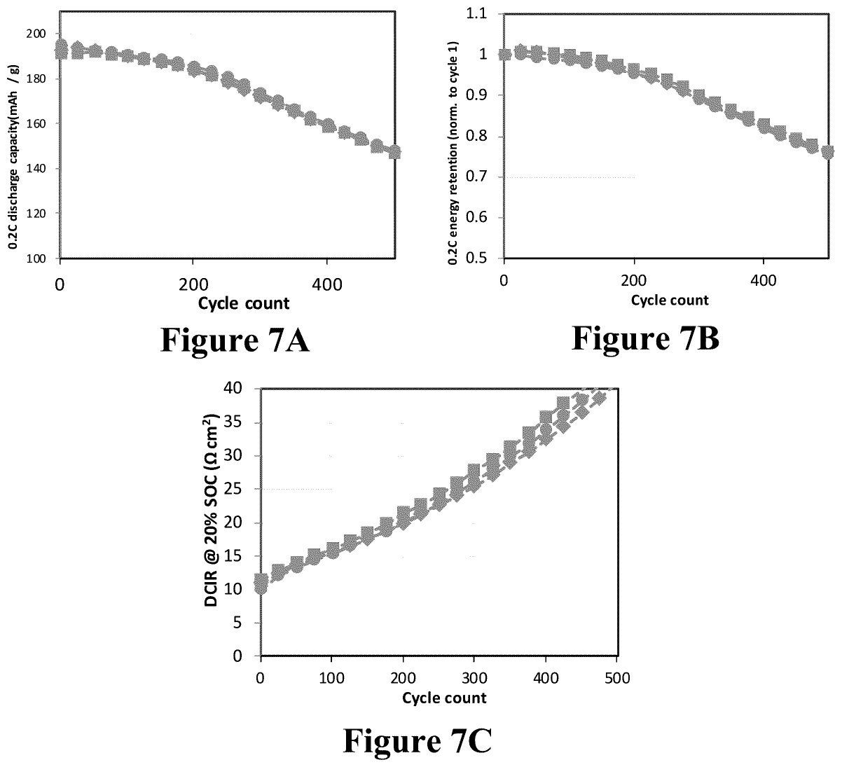

FIG. 7A depicts the discharge capacity as a function of cycle count for Electrolyte Fluid 2 in a battery cell having a blended cathode of 70 wt % LCO and 30 wt % NMC, and operating at 4.52V. The discharge capacity decreases slightly for 200 cycles, and thein decreases slightly more rapidly beginning at approximately cycle 200. FIG. 7B depicts the energy retention normalized to the first cycle as a function of cycle count for Electrolyte Fluid 2 in a battery cell having a blended cathode of 70 wt % LCO and 30 wt % NMC, and operating at 4.52V. Like discharge capacity, the energy retention remains roughly constant through 100 cycles, before decreasing more at approximately 100 cycles. FIG. 7C depicts the DCIR at 20% SoC as a function of cycle count for Electrolyte Fluid 2 in a battery cell having a blended cathode of 70 wt % LCO and 30 wt % NMC, and operating at 4.52V.

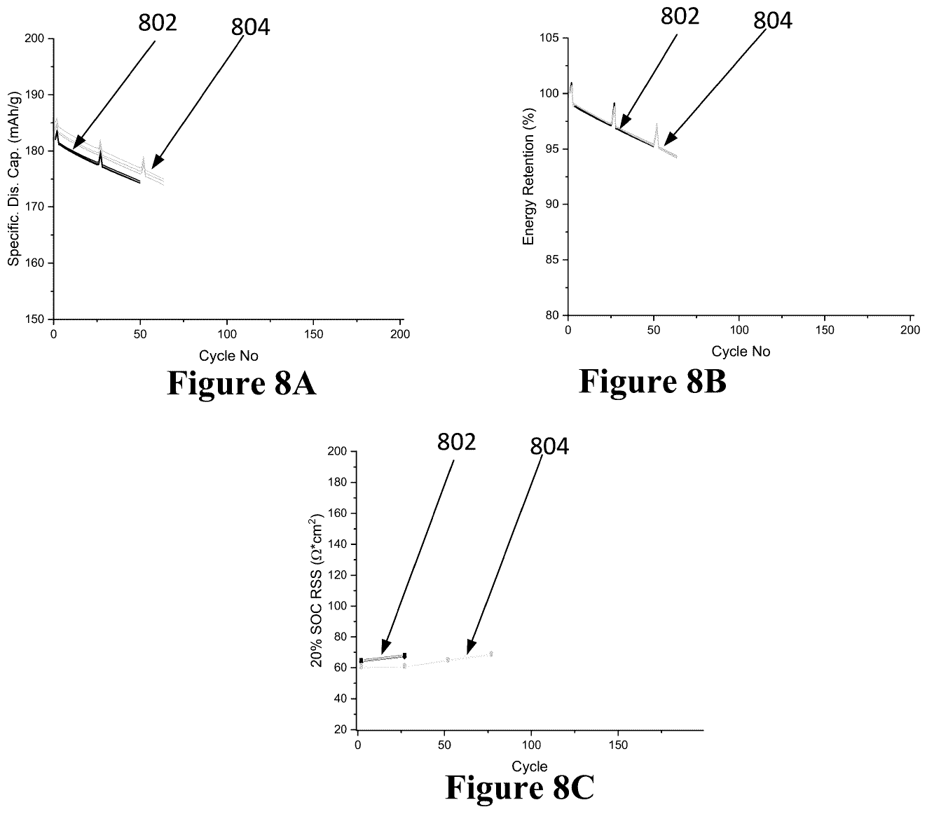

FIG. 8A depicts the specific discharge capacity as a function of cycle count for Electrolyte Fluid 1 and Electrolyte Fluid 2 in a battery cell operating at 4.52V and 45° C. The specific discharge capacity increased with cycle count upon substitution of EMC and DMC (Electrolyte Fluid 2, 804) in place of EP and PP (Electrolyte Fluid 1, 802). FIG. 8B depicts energy retention as a function of cycle count for Electrolyte Fluid 1 and Electrolyte Fluid 2 in a battery cell operating at 4.52V and 45° C.

FIG. 8C depicts the RSS at 20% SoC as a function of cycle count for Electrolyte Fluid 1 and Electrolyte Fluid 2 in a battery cell operating at 4.52V and 45° C. The RSS (internal resistance) decreased with cycle count upon substitution of EMC and DMC (Electrolyte Fluid 2, 804) in place of EP and PP (Electrolyte Fluid 1, 802).

TABLE 2A

| Electrolyte | LiPF6 | FEC | EC | PC | PP | EP | DMC | EMC |
|---|---|---|---|---|---|---|---|---|
| Fluid No. | (M) | (wt %) | (wt %) | (wt %) | (wt %) | (wt %) | (wt %) | (wt %) |
| 3 | 1.2 | 15 | 0 | 5 | 30 | 50 | | |
| 4 | 1.2 | 15 | 0 | 5 | | | 30 | 50 |

TABLE 2B

| Electrolyte | | | | | | | |
|---|---|---|---|---|---|---|---|
| Fluid No. | FEC | PS | LiDFOB | SN | HTCN | DFEB | LiMDFB |
| 3 | 8 | 4 | 0.25 | 2 | 3 | 0.3 | 0.25 |
| 4 | 8 | 4 | 0.25 | 2 | 3 | 0.3 | 0.25 |

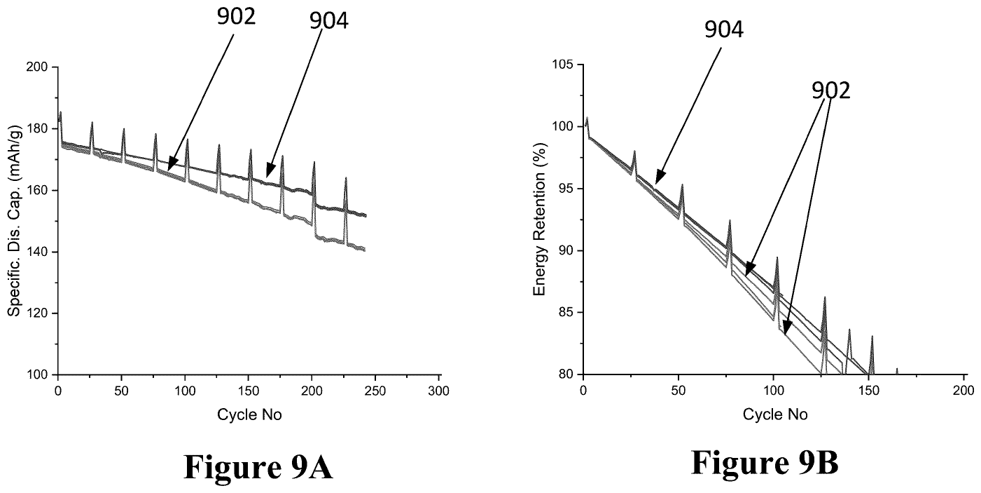

FIG. 9A depicts the specific discharge capacity as a function of cycle count for Electrolyte Fluid 3 and Electrolyte Fluid 4 in a battery cell operating at 4.52V and 25° C. The specific discharge capacity increased with cycle count upon substitution of EMC and DMC (Electrolyte Fluid 4, 904) in place of EP and PP (Electrolyte Fluid 5, 902). Likewise, FIG. 9B depicts energy retention as a function of cycle count for Electrolyte Fluid 3 and Electrolyte Fluid 4 in a battery cell having a blended cathode and operating at 4.52V and 45° C. The energy retention increased with cycle count upon substitution of EMC and DMC (Electrolyte Fluid 4, 904) in place of EP and PP (Electrolyte Fluid 5, 902).

By using a fully carbonated solvent of Electrolyte Fluid 4 in an FEC-based formulation, replacing linear esters EP and PP with linear carbonates DMC/EMC, provides improved fast charge at 25° C. and cycling performance at 45° C.

The electrolyte fluids described herein can be used in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
an electrolyte fluid comprising dimethyl carbonate (DMC) and ethylmethylcarbonate (EMC) disposed between the cathode and the anode.

2. The battery cell of claim 1, wherein the combined quantity of DMC and EMC is 50 wt %-80 wt % of the electrolyte fluid.

3. The battery cell of claim 1, wherein the wt % ratio of DMC:EMC is from 1:4::4:1.

4. The battery cell of claim 1, wherein DMC is in an amount from 10 wt %-70 wt % of the electrolyte fluid, and EMC is in an amount from 10 wt %-70 wt % of the electrolyte fluid, wherein the total amount of DMC and EMC does not exceed 80 wt %.

5. The battery cell of claim 1, wherein DMC is from 20 to 70 wt % of the total electrolyte fluid, and/or EMC is from 10 to 50 wt % of the total electrolyte fluid, wherein the total amount of DMC and EMC does not exceed 80 wt %.

6. The battery cell of claim 1, wherein the solvent comprises propylene carbonate (PC) and ethylene carbonate (EC).

7. The battery cell of claim 6, wherein PC is from 2 to 20 wt % of the total electrolyte fluid and EC is from 5 to 40 wt % of the total electrolyte fluid.

8. The battery cell of claim 1, comprising a lithium salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

9. The battery cell of claim 8, wherein the lithium salt comprises LiPF₆.

10. The battery cell of claim 8, wherein the lithium salt is in an amount of 0.1 M-2.0 M in the electrolyte fluid.

11. The battery cell of claim 1, comprising an additive selected from lithium difluoro(oxalato)borate (LiDFOB), succinonitrile (SN), propane sultone (PS), 1,3,6-hexanetricarbonitrile (HTCN), and a combination thereof.

12. The battery cell of claim 11, wherein the additive comprises LiDFOB.

13. The battery cell of claim 12, wherein the additive comprises 0.1 wt %-3.0 wt % LiDFOB.

14. The battery cell of claim 11, wherein the additive comprises PS.

15. The battery cell of claim 14, wherein the additive comprises 0.5 wt %-10.0 wt % PS.

16. The battery cell of claim 11, wherein the additive comprises SN.

17. The battery cell of claim 16, wherein the additive comprises 0.5 wt %-6.0 wt % SN.

18. The battery cell of claim 1, wherein the additive comprises HTCN.

19. The battery cell of claim 18, wherein the additive comprises 0.5 wt %-6.0 wt % HTCN.

20. The battery cell of claim 1, wherein the additive comprises FEC.

21. The battery cell of claim 20, wherein the additive comprises 3.0 wt %-10.0 wt % FEC.

22. The battery cell of claim 1, where the solvent comprises ethyl propionate (EP), propyl propionate (PP), and a combination thereof.
